(19) United States
(12) Patent Application Publication
(10) Pub. No.: US 2010/0127027 A1
(43) Pub. Date: May 27, 2010

(54) Trailer Storage Compartment

(76) Inventor: Marty Williams, Colorado Springs, CO (US)

Correspondence Address: GLENN L. WEBB;GLENN L. WEBB P.C., P.O BOX 3788, DURANGO, CO, 81302, US

(21) Appl. No.: 12/275,704

(22) Filed: Nov. 21, 2008

(51) Int. Cl. B60R 9/00

(52) U.S. Cl. 224/401

(57) ABSTRACT

A storage compartment for trailers. The storage compartment is mounted on the tongue of the trailer with a bottom tray, cover support members and a flexible cover. The bottom tray includes raised ribs with a circular indentation for securing propane tanks. The tray is mounted to the trailer tongue by the use of C channel members and U bolts. The bottom tray is covered by a flexible cover that is easily removed and seals into a waterproof engagement with the bottom tray.

### FIELD OF THE INVENTION

This invention relates to storage compartments and particularly to trailer mounted storage compartments.

### BACKGROUND OF THE INVENTION

Trailers are increasingly being used for the transport of all types of cargo. This can range from transporting of utility cargo such as boxes, products, as well as all other types of cargo to transporting recreational vehicles such as all terrain vehicles, motorcycles, bicycles, snowmobiles and other vehicles. Specialty trailers are also widely used, such as recreational vehicles, camping trailers, as well as trailers used for special uses such as for cooking and food product preparations, and practically any other use.

Additional storage is often required, such as for tools, for hazardous cargo, cargo that might contaminate the surrounding cargo, and for clothing or other items that are desired to be stored separately from the trailer cargo during transport. Separate storage compartments are often mounted on the trailer for these uses.

One example of such storage compartments include metal storage boxes mounted onto the trailer tongue for use in storing tools and other items. These metal storage boxes are permanently mounted to the trailer tongue and add considerable weight to the trailer and particularly to the trailer tongue which can be problematic. Additionally, these metal storage boxes are cumbersome if they are removed from the trailer.

Often other items such as electrical generator sets that are mounted on the trailer tongue. These are typically mounted inside an insulated shell for protection. These are cumbersome to attach and remove. The shells are awkward to access and are not particularly aerodynamic.

The previous trailer storage compartments are relatively heavy, awkward to mount, difficult to remove and are not aerodynamic.

### SUMMARY OF THE INVENTION

The present invention provides a storage compartment that can be easily mounted onto the tongue of a trailer. The storage compartment can be easily accessed to the cargo stored in the compartment. The compartment includes a cover framework that can be easily installed as well as removed when the cover is not required. The cover is flexible and forms a waterproof seal from environmental contamination. The storage compartment can be mounted to most styles of trailer tongues, including single beam and V shaped trailer tongues.

The storage compartment of a preferred embodiment of the present invention includes a bottom tray. The bottom tray is lightweight but rigid and durable. The bottom tray may include a series of raised ribs that maintain the cargo from any residual water in the compartment. Also, a circular indentation may be formed in the tray to secure propane tanks in the compartment.

The storage compartment of a preferred embodiment includes side and top support members which quickly install to the bottom tray. The side and top support members support a flexible cover that is mounted over the supports. The flexible cover includes snaps that engage on snaps on the bottom tray. In a preferred embodiment, the bottom tray includes a rim portion that extends outward. The snaps are mounted on the bottom tray beneath this rim portion. When the flexible cover snaps onto the snaps of the bottom tray, the rim portion forms a seal with the flexible cover to form a waterproof connection.

The storage compartment of a preferred embodiment includes two side support members that support two top support members. These members install quickly onto the bottom tray. The cover drapes over these members and attach to the bottom tray to cover the tray to form the compartment.

The storage compartment of another preferred embodiment includes a rear support member and a front support member that is of lesser height than the rear support member. Top support members thus extend between these members at a downward slope to provide drainage on the cover.

The storage compartment of another preferred embodiment includes a rear wall member this of greater height than the front wall member. The top support members also extend downward at a slope to provide drainage.

Another preferred embodiment of the storage compartment includes a front wall member. Top support members are mounted to the front wall of the trailer and to the front wall member to frame the storage compartment. Snaps are mounted on the front wall of the trailer and to the bottom tray for the cover to allow the cover to be attached.

These and other features will be evident from the ensuing detailed description of preferred embodiments, the claims and from the drawings.

### BRIEF DESCRIPTION OF DRAWINGS

FIG. 1 is a perspective view of the storage compartment of a preferred embodiment of the present invention mounted on a trailer tongue.

FIG. 2 is a view of the storage compartment of the embodiment of FIG. 1 with the cover partially removed.

FIG. 3 is a view of the storage compartment of the embodiment of FIG. 1 with the cover removed.

FIG. 4 is a view of the storage compartment of the embodiment of FIG. 1 with bottom tray removed from the trailer tongue.

FIG. 5 is a view of the storage compartment of the embodiment of FIG. 1 showing the use of the C channel members.

FIG. 6 is a view of the storage compartment of the embodiment of FIG. 1 with the bottom bracket plate being mounted.

FIG. 7 is a view of the storage compartment of the embodiment of FIG. 1 with the cover being applied.

FIG. 8 is a view of the storage compartment of the embodiment of FIG. 1 with the cover side flaps being folded downward.

FIG. 9 is a view of the storage compartment of the embodiment of FIG. 1 being mounted with spacer blocks on a V shaped tongue.

FIG. 10 is a view of the storage compartment of the embodiment of FIG. 1 with the being mounted on a V shaped tongue with C channel members.

FIG. 11 is a view of the storage compartment of the embodiment of FIG. 1 being mounted directly on a V shaped tongue.

FIG. 12 is a view of the storage compartment of the embodiment of FIG. 1 being mounted directly on a V shaped tongue with securing plates.

FIG. 13 is a view of the storage compartment of the embodiment of FIG. 1 mounted directly on a V shaped tongue with the cover being applied.

FIG. 14 is a view of the storage compartment of the embodiment of FIG. 1 mounted directly on a V shaped tongue with the side flaps of the cover being folded downward.

FIG. 15 is a view of the storage compartment of the embodiment of FIG. 1 mounted directly on a V shaped tongue with the cover fully engaged.

FIG. 16 is a perspective view of the storage compartment of an alternative embodiment having an angled upper surface.

FIG. 17 is a perspective view of the storage compartment of an alternative embodiment having an angled upper surface and a rear wall member.

FIG. 18 is a perspective view of the storage compartment of an alternative embodiment having an angled upper surface and the trailer wall forming the rear support.

FIG. 19 is a perspective view of the embodiment of FIG. 18 storing propane tanks.

FIG. 20 is a perspective view of the embodiment of FIG. 18 with the cover fully engaged.

FIG. 21 is a perspective view of the embodiment of FIG. 18 with the cover partially open.

### DETAILED DESCRIPTION OF PREFERRED EMBODIMENTS

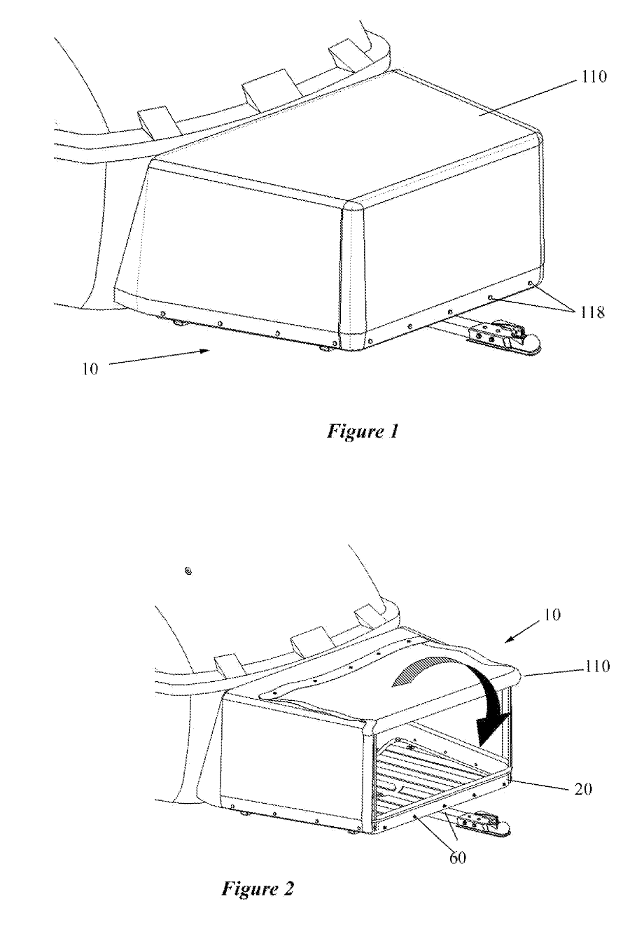

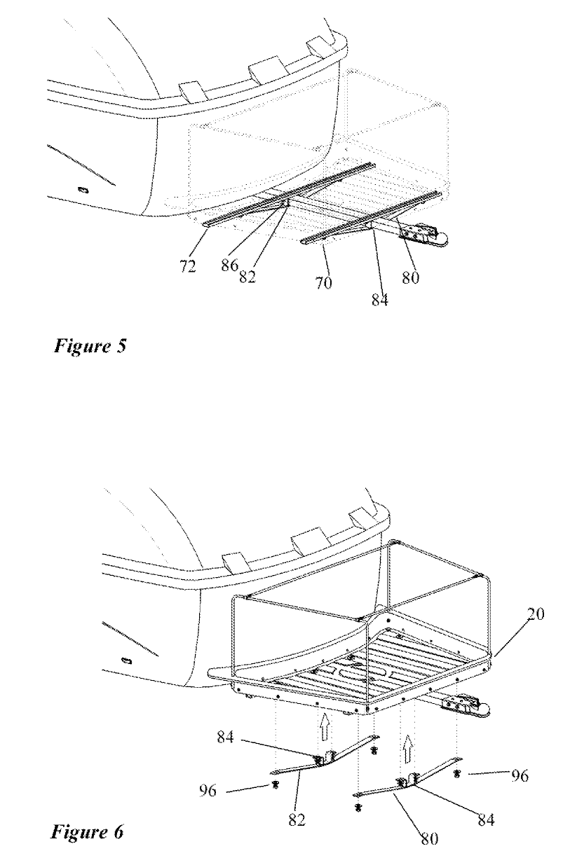

A preferred embodiment of the present invention is illustrated in FIGS. 1-15. It is to be expressly understood that the descriptive embodiment is provided herein for explanatory purposes only and is not meant to unduly limit the claimed inventions. The preferred embodiment of the present invention is intended for use with trailers and other towable devices. It is to be expressly understood that the present invention may be incorporated with other uses as well.

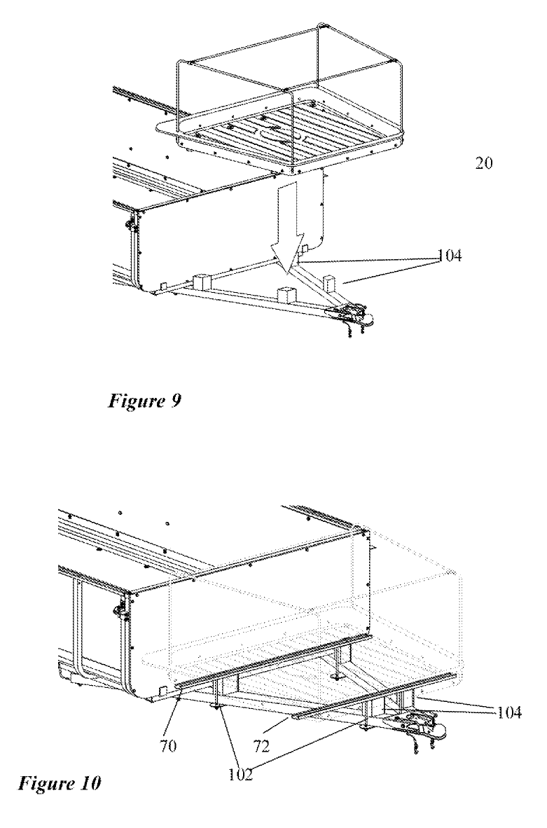

The storage compartment 10 of a preferred embodiment is illustrated in FIGS. 1-15. The storage compartment 10 includes a bottom tray 20 with frame work 40 and cover 110. The compartment 10 is mountable on different types of trailer tongues including a V shaped tongue, as showed in FIGS. 9-15 or on a single pole tongue as shown in FIGS. 1-7.

The bottom tray 20 of the storage compartment is preferably a molded plastic component although it could be formed from other materials as well such as aluminum, steel grating, expanded mesh, wood or any other suitable material. The bottom tray of the preferred embodiment includes floor portion 22 with a series of ribs 24 that allow drainage. The tray 20 also has side walls 26 and rim portion 28. Drain holes 30 also provide drainage and can be plugged if desired. Spaced notches 32 form an indented ring for placement of a propane tank, as discussed in greater detail below. A series of snaps 60 are spaced along the perimeter of the lower outer wall of the bottom tray 20. Other types of fastening mechanisms may be used as well.

The frame work 40 includes side members 42, 44 and support members 52, 54. The side members and support members are formed from aluminum or steel rods, or they can be plastic or any other suitable material. The side members 42, 44 include vertical portions 46, 48 and horizontal portion 50 connecting the vertical portions to form an upside “U” shape. The support members 52, 54 are mounted on the horizontal portions 50 of the side members by clamps 56, 58 or apertures formed or mounted on the support members. The support members can be mounted on the side members prior to mounting the side members on the bottom tray.

The lower ends of vertical portions 46, 48 of each of the side members are inserted through holes 34 formed in the rim portion 28 of the bottom tray 20. The side members can either be inserted securely in pockets formed in the bottom tray there, or else secured with bolts or pins to secure the side members 42, 44 to the bottom tray.

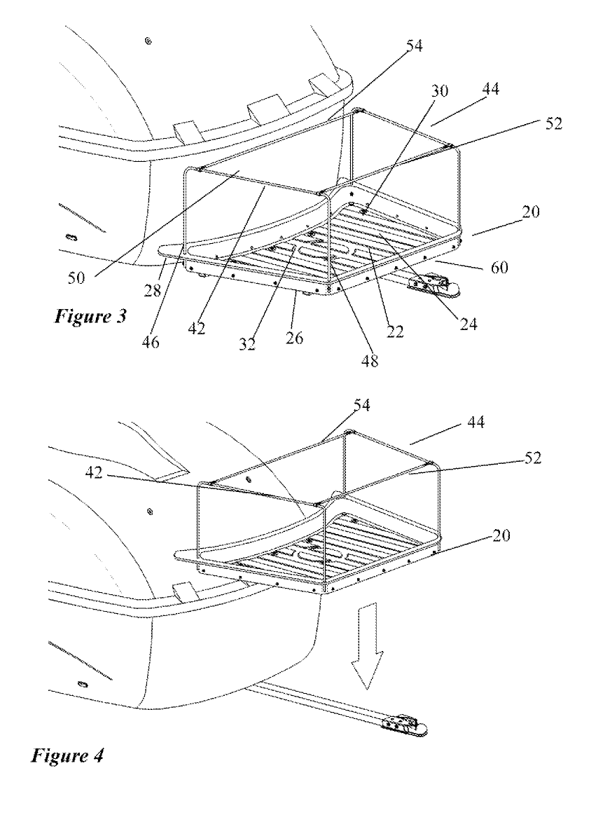

The bottom tray 20 is mounted to the trailer tongue by one of several methods, depending on the design of the trailer tongue. If the trailer tongue is a single straight beam, then the compartment 10 is mounted on the tongue as shown in FIGS. 1-8. Two spaced C channel members 70, 72 are mounted to the upper side of the bottom tray 20 as shown in FIG. 3. In the preferred embodiment, U bolts 76 are inserted into holes formed in the bottom tray 20 and through holes in the channels 74 of the C channel members 70, 72. It is to be expressly understood that other members could be used as well, such as bolts, etc. to be secured to the bottom tray.

Elongated flat members 80, 82 having brackets 84, 86 are secured to the C channel members 70, 72 with the trailer tongue 100 engaged in the brackets 84, 86. The bolts 76 are inserted through holes formed in the C channel members 70, 72 through holes 88, 90, 92, 94 formed in each of the flat members and brackets. Nuts 96 engaging the bolts 76 secure the members 80, 82 to C channel members 70, 72.

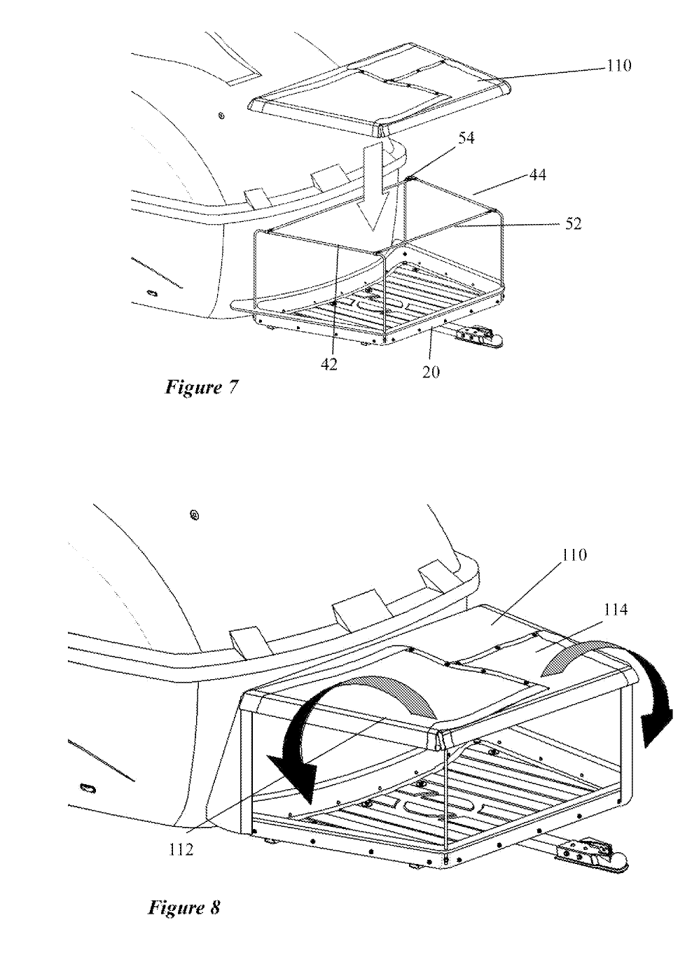

Once the framework and tray are mounted on the tongue, the cover 110 is secured to it. The cover 110 is placed on the top support members 52, 54 and side support members 42, 44 as shown in FIG. 7. The side flaps 112, 114 of the cover 110 are then folded down as shown in FIG. 8. Snaps 118 on the cover engage the snaps 60 on the bottom tray to secure the cover 110 to the compartment.

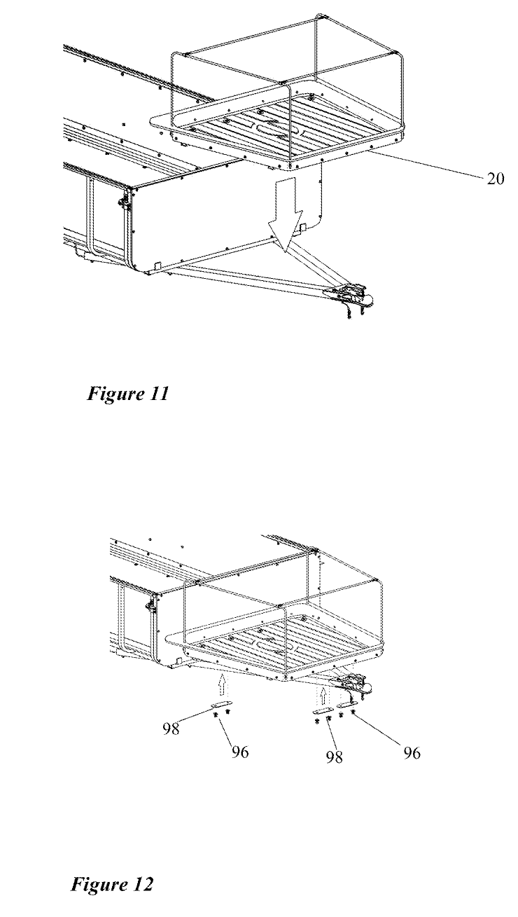

Alternatively, if the trailer tongue is a V shape tongue, then the attachment mechanism is slightly different. The C channel members 70, 72 are secured to the bottom tray 20 in a similar fashion. The bottom tray and C channel members 70, 72 mount onto the two tongue members either on spacers 100 as shown in FIGS. 9 and 10 or directly onto the tongue members as shown in FIGS. 11 and 12. If the compartment is mounted directly on the tongue members, as shown in FIGS. 11 and 12, then straps 98 are secured to the bolts extending through C channel members by nuts 96. This secures the compartment to the tongue.

If the compartment is mounted on spacers 104, as shown in FIGS. 9 and 10, then U bolts 102 extend through the C channel members. The U bolts 102 are secured through straps 98 by nuts 96 to secure the storage compartment to the trailer tongue.

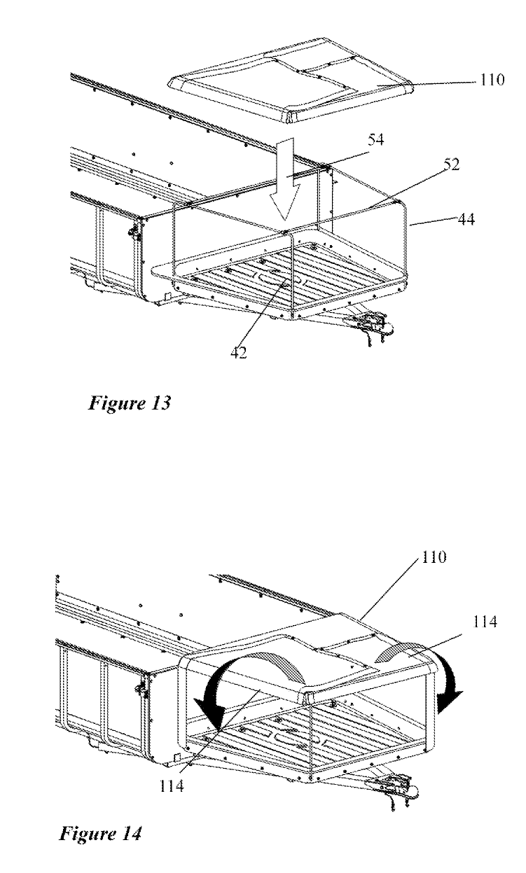

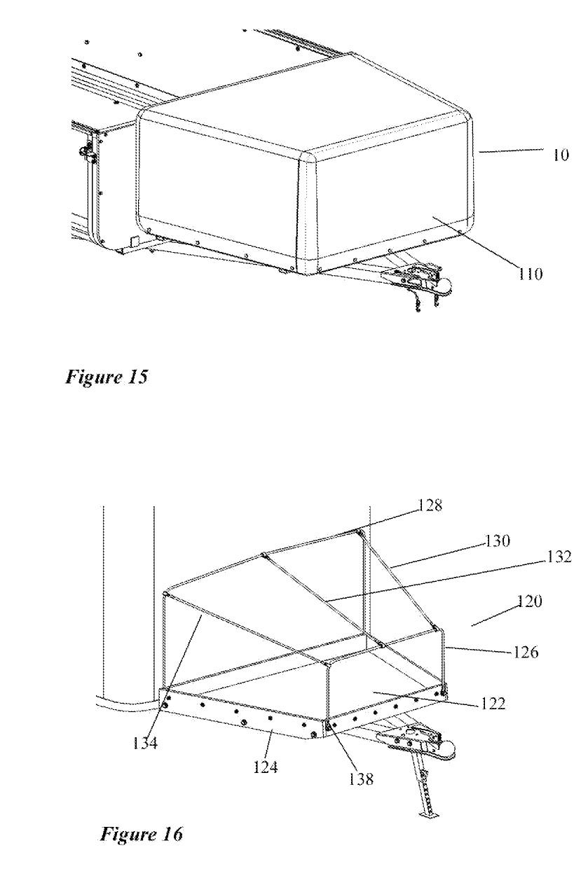

Once the storage compartment 10 is mounted to the trailer tongue, cover 110 is mounted to the compartment over the frame work 30 as shown. The cover is placed over the side members 42, 44 and the support members 52, 54 as shown in FIGS. 13-14. The side flaps 112, 114 are folded down over the side members so that the snaps 116 on the cover engage the snaps 60 on the lower sides of the bottom tray 20 of the compartment as shown in FIG. 15. The cover is stretched over the rim of the bottom tray to engage the snaps beneath the rim which seals the interior of the compartment.

Once the cover has been fully snapped around the perimeter of the tray, the storage compartment can be accessed by unzipping the side openings to access the compartment. Alternatively the compartment can be accessed by unsnapping the snaps 116 from snaps 60.

### Alternative Embodiment

An alternative embodiment is illustrated in FIG. 16. The storage compartment 120 includes a base tray 122 that is mounted directly onto the trailer tongue. C channel members 80, 82 can be used, or the base tray 122 can be bolted or welded directly onto the tongue. Side members 124 are attached to the base tray either by bolts as shown or integrally by forming or welding, or by other fastening mechanisms. This embodiment includes front support member 126, rear support member 128 and support members 130, 132, 134. The top support members 130-134 are mounted on to front support and rear support members by clamps 136 or other securing mechanisms. The front and rear support members are secured to the front and rear side members 124, respectively, by bolts 138. The front support member 126 has a slightly lower height than the rear support member 128. This provides drainage from the cover once it has been mounted to the compartment.

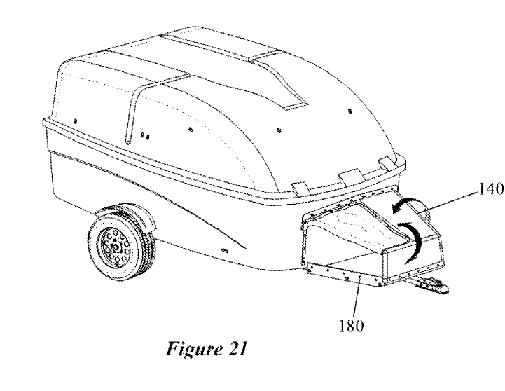

A cover 140, such as shown in FIG. 20, is mounted over the front, rear and top support members by engaging snaps on the cover with snaps 142 on the side members 124. Access to the compartment can be by disengaging the snaps or by unzipping side and front openings on the cover as shown in FIG. 21.

### Alternative Embodiment

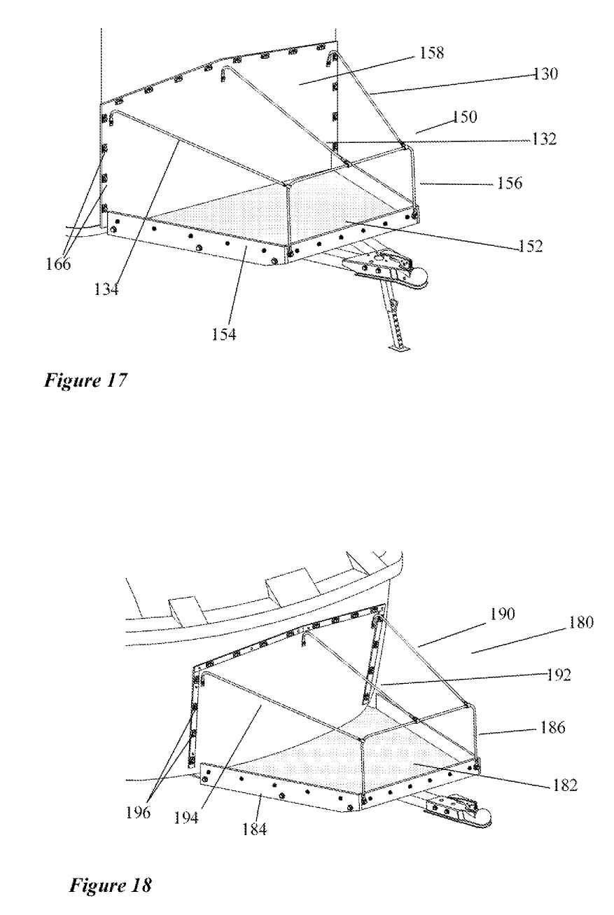

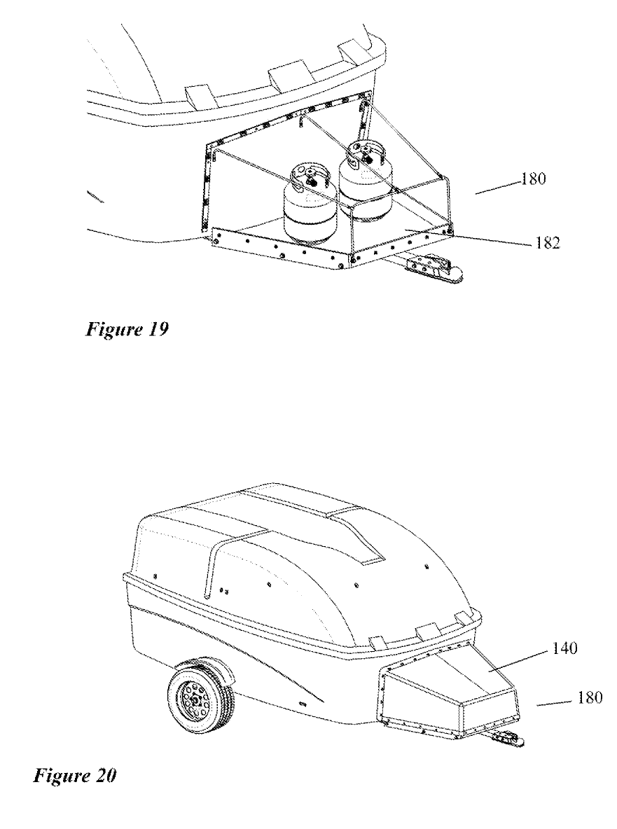

Another alternative embodiment is illustrated in FIG. 17. The storage compartment 150 includes a base tray 152 that is mounted directly onto the trailer tongue. C channel members 80, 82 can be used, or the base tray 152 can be bolted or welded directly onto the tongue. Side members 154 are attached to the base tray either by bolts as shown or integrally by forming or welding, or by other fastening mechanisms. This embodiment includes front support member 156, rear support wall 158 and support members 130, 132, 134. The top support members 130-134 are mounted on to front support by clamps 136 or other securing mechanisms. The front member is secured to bottom tray 152 by bolts 138. The rear wall 158 is bolted to the rear side member 154 and extends upward. The top support members 160, 162, 164 are bolted directly onto the rear wall member, as shown in FIG. 17. The rear wall member also includes a plurality of snaps 166 spaced from one another. The rear wall member has a greater height than the front wall member to provide drainage from the cover.

A cover 140, such as shown in FIG. 20, is mounted over the front and top support members by engaging snaps 172 on the cover with snaps 174 on the side members 154 and snaps 166 on the rear wall member 158. Access to the compartment can be by disengaging the snaps or by unzipping side and front openings on the cover as shown.

### Alternative Embodiment

A third alternative embodiment is illustrated in FIG. 18. The storage compartment 180 includes a base tray 182 that is mounted directly onto the trailer tongue. C channel members 80, 82 can be used, or the base tray 182 can be bolted or welded directly onto the tongue. Side members 184 are attached to the base tray either by bolts as shown or integrally by forming or welding, or by other fastening mechanisms. This embodiment includes front support member 186 and support members 190, 192, 194. The top support members 190-194 are mounted on to front support by clamps 196 or other securing mechanisms. The front member is secured to bottom tray 182 by bolts 188. The top support members 190, 192, 194 are bolted directly onto the front trailer wall as shown in FIG. 17. A plurality of snaps 196 spaced from one another are also mounted directly onto the front trailer wall.

A cover 140 is mounted over the front and top support members by engaging snaps 202 on the cover with snaps 204 on the side members 184 and snaps 196 on the front wall of the trailer. Access to the compartment can be by disengaging the snaps or by unzipping side and front openings on the cover as shown.

### SUMMARY

The present invention provides a unique storage compartment for mounting onto the tongue of a trailer. The storage compartment can store numerous items, such as hazardous cargo, propane tanks, gas cans, etc. apart from cargo in the trailer. Also, items such as generators, winches, and other items can easily and safely be stored. The storage compartment can be integrally mounted on the trailer tongue or removably attached. A flexible cover and frame work can be quickly installed if the cargo is to be covered.

These descriptive embodiments are provided for explanatory purposes and are not meant to limit the scope of the claimed invention. Other embodiments are considered to be within the scope of the claimed inventions.

What is claimed is:

1. A storage compartment for trailers, wherein said storage compartment comprises:
a bottom tray;
a fastening mechanism for fastening said bottom tray to the tongue of a trailer;
at least one side support member;
at least one top support member;
a flexible cover mounted over said at least one side support member and said at least one top support member; and
a fastening mechanism for securing said flexible cover to said bottom tray.

2. The storage compartment of claim 1 wherein said bottom tray includes:
a series of raised ribs to maintain cargo stored in said storage compartment above any residual water in the compartment.

3. The storage compartment of claim 1 wherein said bottom tray includes:
a series of raised ribs to maintain cargo stored in said storage compartment above any residual water; and
a series of indentations in said raised ribs forming a circular indentation.

4. The storage compartment of claim 1 where said fastening mechanism includes:
at least one U bolt extending through said bottom tray and on either side of the trailer tongue;
a plate for each of said at least one U bolts with holes through which each side of the U bolt extends; and
fasteners for securing said at least one U bolts against said plate.

5. The storage compartment of claim 1 wherein said fastening mechanism includes:
at least one C channel member extending across said bottom tray; and
at least one bolt extending through said C channel and engaging the tongue of the trailer; and
a fastener for said at least one bolt to secure said at least one bolt to the trailer tongue.

6. The storage compartment of claim 1 wherein said fastening mechanism includes:
a securing plate;
at least one bracket on said securing plate that engages around the tongue of the trailer; and
bolts that secure said securing plate to said bottom plate.

7. The storage compartment of claim 1 wherein said bottom tray includes:
a plurality of snaps on the exterior of said bottom tray; and
a plurality of snaps on said flexible cover that engage said plurality of snaps on said bottom tray.

8. The storage compartment of claim 1 wherein said bottom tray includes:
an outer rim on said bottom tray extending outward;
a plurality of snaps on the exterior of said bottom tray beneath said outer rim; and
a plurality of snaps on said flexible cover that engage said plurality of snaps on said bottom tray beneath said outer rim to secure said flexible cover to said bottom tray and seal said flexible cover to said bottom tray.

9. The storage compartment of claim wherein said fastening mechanism includes:
spacer blocks mounted between said bottom trailer and the tongue of the trailer.

10. The storage compartment of claim 1 wherein said at least one side support member includes:
two side support members spaced on opposite sides of said bottom tray; and
said at least one top support member includes two top support members attached between said two side support members and spaced from one another.

11. The storage compartment of claim 1 wherein said at least one side support member includes:
a front support member attached to the front of said bottom tray;
a rear support member having a greater height than said front support member and attached to the rear of said bottom tray; and
said at least one top support member includes at least two top support members mounted between said front support member and said rear support member.

12. The storage compartment of claim 1 wherein said at least one side support member includes:
a rear wall member;
a front wall support; and
said at least one top support member includes at least two top support members extending between said rear wall member and said front wall support.

13. The storage compartment of claim 1 wherein said at least one side support member includes:
a rear wall member;
a front wall support having a height less than said rear wall member; and
said at least one top support member includes at least two top support members extending between said rear wall member and said front wall support.

14. The storage compartment of claim 1 wherein said at least one side support member includes:
a front wall support;
a plurality of fasteners mounted on the front wall of the trailer; and
said at least one top support member includes at least two top support members mounted between said front wall support and the front wall of the trailer.

15. The storage compartment of claim 1 wherein said at least one side support member includes:
a front wall support;
a plurality of fasteners mounted on the front wall of the trailer outside the perimeter of said front wall support; and
said at least one top support member includes at least two top support members mounted between said front wall support and the front wall of the trailer.
